(19) United States
(12) Patent Application Publication
(10) Pub. No.: US 2024/0093905 A1
(43) Pub. Date: Mar. 21, 2024

(54) HEATING DEVICE FOR HEATING WATER, AND WATER CONDUCTING APPLIANCE COMPRISING A HEATING DEVICE

(71) Applicant: Miele & Cie. KG, Guetersloh (DE)

(72) Inventors: Daniel EBKE, Bielefeld (DE); Werner STROTHOFF, Sassenberg (DE); Rainer BICKER, Verl (DE); Volker ENNEN, Buende (DE)

(21) Appl. No.: 18/267,263

(22) PCT Filed: Nov. 30, 2021
(86) PCT No.: PCT/EP2021/083556

§ 371 Date: Jun. 14, 2023

(30) Foreign Application Priority Data
Dec. 14, 2020 (BE) 2020/5916

(51) Int. Cl. F24H 1/10; A47J 31/54; D06F 34/22; D06F 39/04; F24H 9/1818; F24H 15/37

(52) U.S. Cl. CPC F24H 1/106; A47J 31/545; D06F 34/22; D06F 39/04; F24H 9/1818; F24H 15/37; D06F 2105/28

(57) ABSTRACT

A heating device for heating water, having a container having an inlet channel and an outlet channel, two spaced-apart plates which act as electrodes and each comprise an electrical connection for connection to an electrical voltage source for generating a current flow through the water located between the plates, wherein at least one plate is mounted movably in order to change the distance between the plates and thereby the volume provided between the plates. A water-conducting device such as a washing machine, dishwasher or hot beverage maker, includes a flow conducting system and a heating device arranged therein, as described above.

### RELATED APPLICATIONS

The present disclosure claims priority to and the benefit of PCT Application PCT/EP2021/083556, filed on Nov. 30, 2021, which claims priority to and the benefit of Belgium Application 2020/5916, filed on Dec. 14, 2020, the entire contents of both of which are incorporated herein by reference.

### TECHNICAL FIELD

The disclosure relates to a heating device for heating water, comprising a container having an inlet channel and an outlet channel.

### BACKGROUND

Water-conducting devices, such as washing machines, dishwashers or beverage makers, require heated water during operation, which is provided by means of a heating element or an instantaneous water heater mounted in the treatment container. In this case, electrical resistance heating elements are used which heat up when connected to electrical current and, due to contact with the water, transfer the heat into the water. This means that a heat transfer from the heating element to the water always takes place, which is lossy or prolongates heating of the water.

DE 10 2014 217 842 A1 discloses a heating device for a beverage maker in the form of an instantaneous water heater.

### SUMMARY

The object of the disclosure is to provide an improved heating device for efficient and safe operation when heating water.

According to the disclosure, this object is achieved, inter alia, by a heating device having the features of independent claim 1 and by a water-conducting device according to claim 12. Advantageous embodiments and developments of the disclosure can be found in the respective dependent claims.

An advantage that can be achieved with the disclosure is that heating is very precise and the temperature specified by the user or the process control is maintained very precisely with extremely small deviations. Furthermore, the water is heated more quickly than with conventional instantaneous water heaters, hotplates, or immersion heaters.

For this purpose, the heating device comprises two spaced-apart plates within the container, which act as electrodes and each comprise an electrical connection for connection to an electrical voltage source in order to generate a current flow through the water located between the plates. At least one plate is mounted movably in order to change the distance between the plates and thereby the volume provided between the plates. The electrodes conduct the voltage applied to the plates directly into the liquid so that an electrical current flows through the water which is located in the spanned space between the two plates. Due to the electrical conductance or resistance of water, it is heated without a heat transfer from a heated body to the water taking place. The water is thus heated directly. Preferably, an AC voltage in the frequency range of the usual mains frequency is used on the electrodes in order to prevent electrolysis, i.e., to reduce it or not allow it to occur. The conductance is changed with the variable distance between the plates, wherein the electric conductance between the plates increases at a smaller distance and decreases at a greater distance. The conductance is furthermore strongly dependent on the properties or composition of the water, in particular on mineral additives, so that the distance between the plates can be adjusted accordingly in order to enable the desired electrical current flow. The plates are preferably spaced parallel to one another. Since the plates act as electrodes, they must have only a low transition resistance to the water so that they preferably consist of graphite or have a graphite surface. Overall, the heating device is designed for use in a water-conducting device, preferably for use in a washing machine, a dishwasher, or a hot beverage maker.

In an advantageous embodiment, the heating device comprises a drive means for moving the movable plate, and a control device for controlling or activating and deactivating the drive means. The distance can thus be set automatically, depending on the process requirements of the device in which the heating device is inserted.

In a preferred development, the heating device comprises a detection means for detecting the conductance of the water located between the plates. The control device is preferably configured to set the distance of the plates from one another as a function of the detected conductance. The conductance is furthermore strongly dependent on the properties or composition of the water, in particular on mineral additives and the temperature, so that the distance between the plates can be adjusted automatically as a function of the properties and process requirements.

In an overall expedient embodiment, the drive means comprises a controllable motor/actuator with a lever mechanism for connecting the motor/actuator to the movable plate. This is a particularly simple variant because the actuator must be arranged outside the reactor container, wherein coupling and guidance of the movable plate take place by means of the lever transmission.

In another, overall advantageous embodiment, the drive means comprises a controllable motor with a spindle coupled thereto for connecting or coupling the motor to the movable plate. A plurality of different distances can thus be set in a simple manner. In combination with the detection of the conductance, a very delicate control of the current flow can be provided. Guidance of the movable plate can be provided by means of a lever mechanism or a rail guide in order to provide a linear movement transverse to the surface area of the plate.

In an overall expedient embodiment, the container volume is in the range of 50 ml to 2000 ml. This is sufficient for a heating device of the aforementioned type for most applications in water-conducting household appliances and can be accommodated in the corresponding devices without notable constructive effort.

In a further, overall expedient embodiment, the plate size has a value in the range of 10 cm2 to 500 cm2, wherein the distance of the plates is configured to be variable in a range of 5 cm to 0.5 cm.

The disclosure further relates to a water-conducting device such as a washing machine, dishwasher or hot beverage maker, comprising a flow conducting system and a heating device arranged therein according to one of the above-mentioned embodiments.

### BRIEF DESCRIPTION OF THE DRAWINGS

An embodiment of the disclosure is shown purely schematically in the drawings and is described in more detail below. In the drawings:

FIGS. 1, 2 show a heating device in different situations in a first embodiment;

FIGS. 3, 4 show a heating device in different situations in a second embodiment;

FIG. 5 shows a hot beverage maker in a sketched perspective open view, and

FIG. 6 shows a schematic view of a washing machine.

### DETAILED DESCRIPTION OF THE DRAWINGS

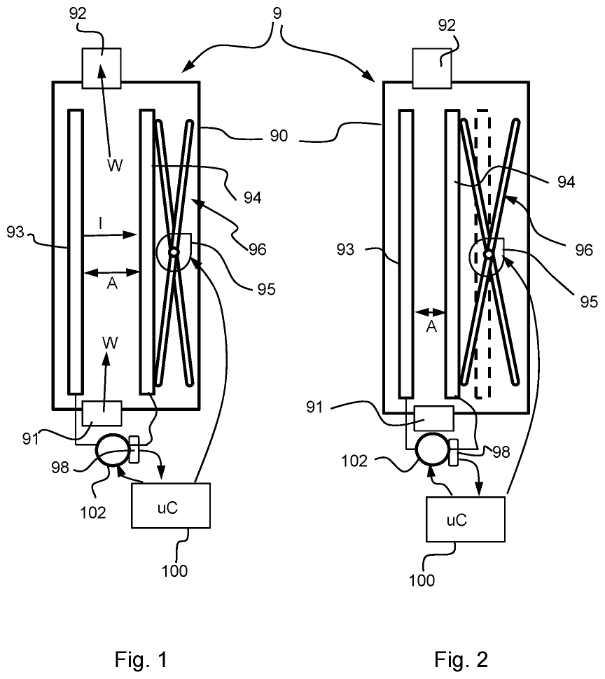

FIG. 1 schematically shows the heating device 9 in a first embodiment. This device 9 comprises a container 90 having an inlet channel 91 and an outlet channel 92 and two spaced-apart plates 93, 94 in the container 90, which act as electrodes and each comprise an electrical connection for connection to an electrical voltage source 102 for generating a current flow I through the water W located between the plates, wherein at least one plate 94 is mounted movably in order to change the distance between the plates 93, 94 and thus the water volume provided between the plates 93, 94. FIG. 1 shows the situation in which the plates 93, 94 have a large distance A from one another. The movable plate 94 is guided in the container 90 by means of a lever mechanism 96. A drive means 95 serves to drive the lever mechanism in order to move the plate 94 in order to change the parallel distance between the plate 94 and the stationary plate 93. The control device 100 is configured to switch the corresponding AC voltage to the plates 93, 94 and to activate the drive means 95 in order to set the distance A of the plates 93, 94 to one another. With the detector 98, such a conductivity detector, sensor, probe or equivalent detection means, the conductance of the liquid W located in the container can be detected and supplied to the control device 100. The control device 100 can activate the drive means 95 on the basis of the detected conductance and the defined requirements for water heating in order to set the distance A such that an electrical current flow I is established which leads to the desired heating of the water W. In this case, the heating device 9 is designed as an instantaneous water heater, but it can also be designed as a boiler. Due to the AC voltage applied to the plates 93. 94, the current I is an alternating current with the same frequency.

FIG. 2 shows the heating device 9 according to the embodiment described above, but with a changed position of the movable plate 94. Here, the plate 94 is moved in the direction of the stationary plate 93 so that the two plates 93, 94 are located at a smaller distance A from one another, relative to the situation outlined in FIG. 1. In this case, the lever mechanism 96 serves to convert the rotational movement of the drive means 95 into a linear movement and to guide the movable plate 94 in a stable manner.

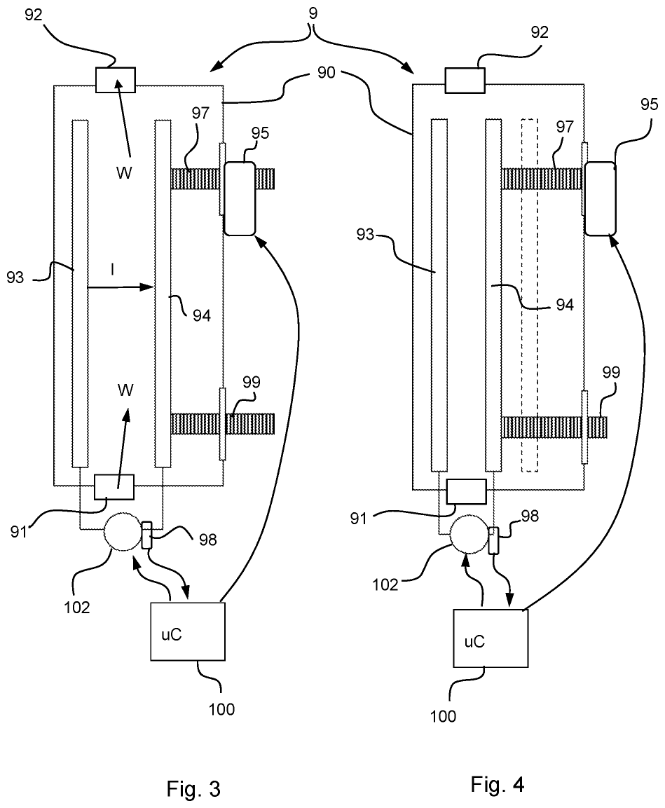

FIG. 3 schematically shows the heating device 9 in a second embodiment. This device 9 comprises a container 90 having an inlet channel 91 and an outlet channel 92 and two spaced-apart plates 93, 94 in the container 90, which act as electrodes and each comprise an electrical connection for connection to an electrical voltage source 102 for generating a current flow I through the water W located between the plates 93, 93, wherein at least plate 94 is mounted movably in order to change the distance A between the plates 93, 94 and thus the water volume provided between the plates 93, 94. FIG. 1 shows the situation in which the plates 93, 94 have a large distance from one another. The movable plate 94 is guided in the container 90 by means of a spindle 97. A drive means 95 serves to drive the spindle 97 in order to move the plate 94 in order to change the parallel distance A between the plate 94 and the stationary plate 93. In the example shown, the spindle 97 is designed as a stationary threaded rod which is attached to the rear side of the movable plate 94. The motor 95 drives a corresponding driver which can move the threaded rod 97 linearly. A further guide means 99 serves to stabilize the movable plate 94. The control device 100 is configured to switch the corresponding AC voltage to the plates 93, 94 and to activate the drive means 95 in order to set the distance A of the plates 93, 94 to one another. With the detection means 98, the conductance of the liquid W located in the container can be detected and supplied to the control device 100. The control device 100 can activate the drive means 95 on the basis of the detected conductance and the defined requirements for water heating in order to set the distance such that an electrical current flow I is established which leads to the desired heating of the water W. In this case, the heating device 9 is designed as an instantaneous water heater, but it can also be designed as a boiler. Due to the AC voltage applied to the plates 93. 94, the current I is an alternating current with the same frequency.

FIG. 4 shows the heating device 9 according to the embodiment described above, but with a changed position of the movable plate 94. Here, the plate 94 is moved in the direction of the stationary plate 93 so that the two plates 93, 94 are located at a smaller distance A from one another, relative to the situation outlined in FIG. 3. In this case, the spindle drive 97 serves to convert the rotational movement of the drive means 95 into a linear movement and to guide the movable plate 94 in a stable manner.

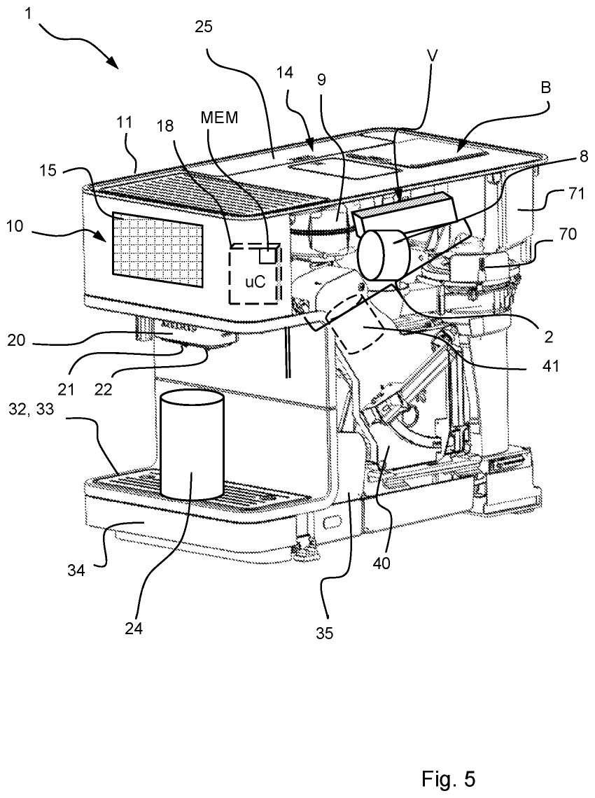

FIG. 5 shows the example of a hot beverage maker 1 designed as a stand-alone device with all relevant components for the preparation of a hot beverage. The beverage maker 1 comprises, inter alia, a housing 11 in which the storage container 71 for coffee beans B with a grinder 70 mounted underneath with a motor, the water tank 14 and the possibility of accommodating the flow conducting system 2. The housing 11 also serves as a support frame for the brewing unit 40, wherein an inclination of the brewing chamber 41 results in the inserted position. In its front region, the hot beverage maker 1 has a height-adjustable outlet 20 in which multiple extraction elements, here outlet nozzles 21, 22, are accommodated. In the present case, the extraction element 22 is a steam nozzle for dispensing hot steam or hot water, for example for diluting a finished coffee or for preparing a tea beverage. The extraction element 21 constitutes a dispensing line or dispensing nozzle 21 for dispensing coffee beverages. A brewing unit 40 with a brewing chamber 41 in the interior of the device 1 serves to prepare the beverage, wherein the coffee powder is introduced into the brewing chamber 41 and is subsequently flooded with hot water so that the finished coffee beverage is dispensed to the discharge line and through the dispensing nozzle 21. The upper end-plate of the storage surface 33 is formed by a drip tray 32 which is provided with openings and slits for discharging liquid residues into a drip pan 34 present below the drip tray 32. Furthermore, the hot beverage maker 1 comprises a coffee grounds container 35, into which the used coffee grounds, for example coffee pucks, are discharged once the beverage has been prepared. The device 1 further comprises a control device 18, which is configured to control the individual functional assemblies, such as pumps 8, valve arrangement V and heating device 9 (designed as an instantaneous water heater) and grinder 70, if present, as is necessary for the preparation of the respectively selected beverage. In this embodiment, the control device 18, which is designed as a microcontroller uC with an associated memory MEM, is moreover configured to control the valves V of the flow conducting system 2 such that the hot water is pumped through the brewing chamber 41. An operating and display device 15 arranged on the front panel 10 provides the means for user inputs and a display for state displays or input options for preparing beverages. The operating and display device 15 is preferably designed as a touch screen. The control tasks for the heating device 8 can be implemented or integrated in the control device 18 beverage maker 1.

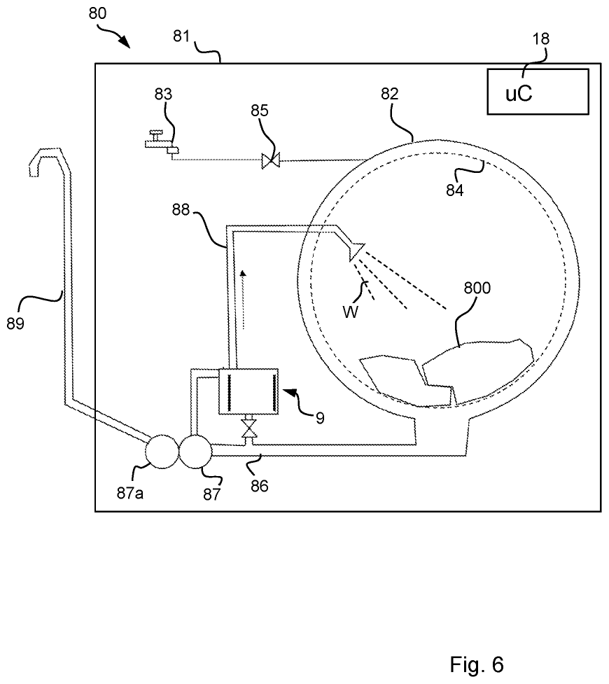

FIG. 6 schematically illustrates a washing machine 80 as an example of a water-conducting device. The washing machine 80 contains a housing 81 in which all essential components for the performance of an automated washing process are necessary. Here, it is the suds container 82, the drum 84 rotatably driven therein, and the control device 18. Furthermore, there is also a water connection 83 for connection to the supply network and a controllable inlet valve 85 in order to introduce water W into the suds container 82 and the drum 84. The drainage device 86 below the suds container 82 serves to connect a circulation pump 87 in order to convey the water W or the suds admixed with washing agent out of the suds container 82 through the circulation line 88 into the upper region of the drum 84 and to inject it there. The heating device 9 is arranged on the pressure side of the pump 87, which heating device 9 is designed as an instantaneous water heater, wherein the circulation line 88 is connected at the outlet 92 (FIGS. 1 to 4) of the heating device 9. Furthermore, the drainage hose 89 is closed off at the drainage device 86 in order to convey the used up suds or water W out of the suds container 82 by means of the drainage pump 87a.

The control device 18 serves to activate and deactivate the pump 87, the drive for the drum 94, the heating device 9 and the valves 85 in order to carry out the desired washing process for the laundry 800. The control tasks for the heating device 9 can be implemented or integrated in the control device 18 of the washing machine 80.

1. A heating device for heating water, comprising
a container having an inlet channel and an outlet channel;
two spaced-apart plates configured to act as electrodes and each comprise an electrical connection for connection to an electrical voltage source for generating a current flow through the water located between the plates,
wherein at least one plate is mounted movably in order to change a distance between the plates and thereby a volume provided between the plates.

2. The heating device according to claim 1, further comprising a drive means for moving the movable plate, and a control device for controlling and/or activating and deactivating the drive means.

3. The heating device according to claim 2, further comprising a detector for detecting the conductance of the water located between the plates.

4. The heating device according to claim 3, wherein the control device is configured to set the distance of the plates from one another as a function of the detected conductance.

5. The heating device according to claim 2, wherein the drive means comprises a controllable motor/actuator with a lever mechanism for connecting the motor/actuator to the movable plate.

6. The heating device according to claim 2, wherein the drive means comprises a controllable motor with a spindle coupled thereto for connecting or coupling the motor to the movable plate.

7. The heating device according to claim 1, wherein the container volume comprises a value in the range 200 ml to 2000 ml.

8. The heating device according to claim 1, wherein the plate size has a value in the range of 10 cm2 to 500 cm2, and the distance of the plates is variable in the range of 5 cm to 0.5 cm.

9. A water-conducting device comprising a flow conducting system and a heating device arranged therein according to claim 1.

10. The water-conducting device according to claim 9, wherein the device is a washing machine, dishwasher or hot beverage maker.
